(19) United States
(12) Patent Application Publication
(10) Pub. No.: US 2017/0292172 A1
(43) Pub. Date: Oct. 12, 2017

(54) METHOD FOR HEAT TREATING LONG STEEL PIPES

(71) Applicant: 9013857 CANADA INC., Westmount, Quebec (CA)

(72) Inventors: Michel Jozef KORWIN, Westmount, Quebec (CA); Dmitro KOSHEL, Laval, Quebec (CA)

(21) Appl. No.: 15/516,838

(22) PCT Filed: Sep. 29, 2015
(86) PCT No.: PCT/CA2015/000526

§ 371 Date: Apr. 4, 2017

(30) Foreign Application Priority Data
Oct. 6, 2014 (CA) 2866646

(51) Int. Cl. C21D 9/14; F16L 9/02; C21D 1/76; C23C 8/26; C23C 8/80

(52) U.S. Cl. CPC C21D 9/14; C23C 8/26; C23C 8/80; C21D 1/76; F16L 9/02

(57) ABSTRACT

A method for heat treating a steel component. The steel component is disposed in a heat treating furnace. The steel component is then exposed to a nitriding atmosphere at a predetermined nitriding temperature for a predetermined nitriding time interval. The nitriding atmosphere has a predetermined composition. The composition of the nitriding atmosphere is controlled while the steel component is exposed thereto. The steel component is slowly cooled to ambient temperature and then removed from the heat treating furnace. The heat treated steel component has substantially increased corrosion and wear resistance compared to the steel component prior the heat treating.

### CROSS-REFERENCE TO RELATED APPLICATIONS

This application is a National Stage filing of International Application No. PCT/CA2015/000526, filed Sep. 29, 2015, which claims priority of Canadian Patent Application No. 2866646, filed Oct. 6, 2014. The entire contents of both of these applications are incorporated herein by reference.

### FIELD

The present invention relates to heat treating processes, and more particularly, to a method for controlled heat treating of long steel pipes to substantially increase corrosion and wear resistance thereof.

### BACKGROUND

Steel pipes used in geothermal heat exchangers and for drilling in, for example, oil and gas exploration are subjected to substantial wear—resulting, for example, from abrasion and cavitation—and substantial corrosion—due to exposure, for example, to salt water, carbon dioxide, and hydrogen sulfide—substantially decreasing their lifespan.

Using state of the art technology, the lifespan of steel pipes for drilling and geothermal heat exchangers is increased by changing the material, applying a protective coating, or electrochemical plating.

The lifespan of the steel pipes is increased by employing specially designed high alloyed steels—for example, stainless steels—instead of carbon steel. Unfortunately, this approach is associated with substantial cost of material—for example, cost of stainless steel vs. carbon steel—and changes in production—including testing and approval—due to substantially different material characteristic requiring different forming and welding procedures.

Alternatively, a protective coating is applied to the carbon steel pipes, for example, Diamond Like Carbon (DLC) coating or polymer coating. US Patent Application 2008/0135296 teaches use of a polyurea based coating for increasing the lifespan of drill pipes. Unfortunately, the application of a protective coating is associated with substantial costs of the process and equipment for applying the coating to the inside and outside surface of pipes—for example, in plasma processes. Furthermore, most protective coatings do not, or only insignificantly, increase the wear resistance and pose the risk of possible coating delamination.

Another state of the art technology is electrochemical plating. For example, hard chrome coating provides good corrosion and wear resistance. However, the coating of the inner surface of pipes is time consuming and expensive.

It is noted that the application of a coating changes the dimension of the pipes, typically, to an extent exceeding manufacturing tolerances, thus requiring design changes.

State of the art heat treating processes such as nitriding or nitrocarburizing processes substantially increase the wear resistance of steel while also increasing the corrosion resistance to some extent. Typically, heat treating processes do not require changes in the design and production of the heat treated component and are implemented in a cost-effective fashion. Unfortunately, state of the art heat treating processes such as, for example, the nitrocarburizing process disclosed in U.S. Pat. No. 4,563,223, involve a quenching step which is associated with a rapid cooling of the heat treated component from the processing temperature—typically greater than 500° C.—to room temperature causing substantial thermal stress. When applied to steel pipes used in drilling and geothermal heat exchangers the thermal stress caused by the quenching step results in a substantial distortion—for example, camber—of the pipe exceeding manufacturing tolerances. Furthermore, the amount of quenching fluid inside the pipe is small, resulting in uneven heat removal from the inner and the outer surface increasing the risk of shape distortion.

It is noted that the application of liquid quenching to long steel pipes also poses a substantial safety hazard since the relatively small amount of quenching liquid inside the long pipe may rapidly evaporate causing an explosive vapor ejection from the pipe.

It may be desirable to provide a method for heat treating a steel component that substantially increases the wear and the corrosion resistance.

It also may be desirable to provide a method for heat treating a steel component that substantially increases the wear and the corrosion resistance while substantially reducing the exposure of the steel component to thermal stress.

It also may be desirable to provide a method for heat treating a steel component that substantially increases the wear and the corrosion resistance and that is applicable for heat treating steel pipes used in drilling and geothermal heat exchangers.

### SUMMARY

Accordingly, one object of the present invention is to provide a method for heat treating a steel component that substantially increases the wear and the corrosion resistance.

Another object of the present invention is to provide a method for heat treating a steel component that substantially increases the wear and the corrosion resistance while substantially reducing the exposure of the steel component to thermal stress.

Another object of the present invention is to provide a method for heat treating a steel component that substantially increases the wear and the corrosion resistance and that is applicable for heat treating steel pipes used in drilling and geothermal heat exchangers.

According to one aspect of the present invention, there is provided a method for heat treating a steel component. The steel component is disposed in a heat treating furnace. The steel component is then exposed to a nitriding atmosphere at a predetermined nitriding temperature for a predetermined nitriding time interval. The nitriding atmosphere has a predetermined composition. The composition of the nitriding atmosphere is controlled while the steel component is exposed thereto. The steel component is slowly cooled to ambient temperature and then removed from the heat treating furnace. The heat treated steel component has substantially increased corrosion and wear resistance compared to the steel component prior the heat treating.

According to another aspect of the present invention, there is provided a method for heat treating a steel component. The steel component is disposed in a heat treating furnace. The steel component is then exposed to a nitriding atmosphere at a predetermined nitriding temperature for a predetermined nitriding time interval. The nitriding atmosphere has a predetermined composition. The composition of the nitriding atmosphere is controlled while the steel component is exposed thereto. For controlling the nitriding atmosphere the same is analyzed and analyzing data are provided in dependence thereupon. Using a processor provision of the composition components of the nitriding atmosphere is determined in dependence upon the analyzing data and the predetermined composition of the nitriding atmosphere and a provision control signal is generated in dependence thereupon. The composition components of the nitriding atmosphere are provided to the heat treating furnace in dependence upon the provision control signal. The steel component is slowly cooled to ambient temperature and then removed from the heat treating furnace. The heat treated steel component has substantially increased corrosion and wear resistance compared to the steel component prior the heat treating.

According to another aspect of the present invention, there is provided a long steel pipe having an inside surface and an outside surface, the inside surface and the outside surface having a heat treating surface layer generated by a method for heat treating. In the method for heat treating the steel pipe is disposed in a heat treating furnace. The steel pipe is then exposed to a nitriding atmosphere at a predetermined nitriding temperature for a predetermined nitriding time interval. The nitriding atmosphere has a predetermined composition. The composition of the nitriding atmosphere is controlled while the steel pipe is exposed thereto. The steel pipe is slowly cooled to ambient temperature and then removed from the heat treating furnace. The heat treated steel pipe has substantially increased corrosion and wear resistance compared to the steel pipe prior the heat treating.

According to another aspect of the present invention, there is provided a long steel pipe having an inside surface and an outside surface, wherein the inside surface and the outside surface has a heat treating surface layer providing substantial corrosion and wear resistance, and wherein the steel pipe has a camber of less than 1.1 mm per one meter of length.

An advantage of the disclosed method is that it provides a method for heat treating a steel component that substantially increases the wear and the corrosion resistance.

A further advantage of the disclosed method is that it provides a method for heat treating a steel component that substantially increases the wear and the corrosion resistance while substantially reducing the exposure of the steel component to thermal stress.

A further advantage of the disclosed method is that it provides a method for heat treating a steel component that substantially increases the wear and the corrosion resistance and that is applicable for heat treating steel pipes used in drilling and geothermal heat exchangers.

### BRIEF DESCRIPTION OF THE DRAWINGS

An embodiment of the present invention is described below with reference to the accompanying drawings, in which:

FIG. 1a is a simplified flow diagram illustrating a method for heat treating a steel component according to an embodiment of the invention;

FIGS. 1b and 1c are simplified flow diagrams illustrating a control process of the method for heat treating a steel component according to an embodiment of the invention;

FIG. 2 is a simplified block diagram illustrating a heat treating furnace system adapted for implementing the method for heat treating a steel component according to an embodiment of the invention;

FIGS. 3a and 3b are simplified block diagrams illustrating a cross sectional view and a side view, respectively, of a long steel pipe for heat treating using method for heat treating a steel component according to an embodiment of the invention;

FIG. 4a is a simplified block diagrams illustrating a cross sectional view of a heat treating furnace adapted for heat treating long steel pipes using method for heat treating a steel component according to an embodiment of the invention; and,

FIG. 4b is a simplified block diagram illustrating a top view of a rack for holding the steel pipes inside the heat treating furnace shown in FIG. 4a.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of the embodiments hereinbelow is with reference to heat treating of carbon steel pipes used in drilling and geothermal heat exchangers, it will become evident to those skilled in the art that the embodiments of the invention are not limited thereto, but are also adaptable for heat treating various other steel components as well as other types of steels such as alloyed steels and stainless steels.

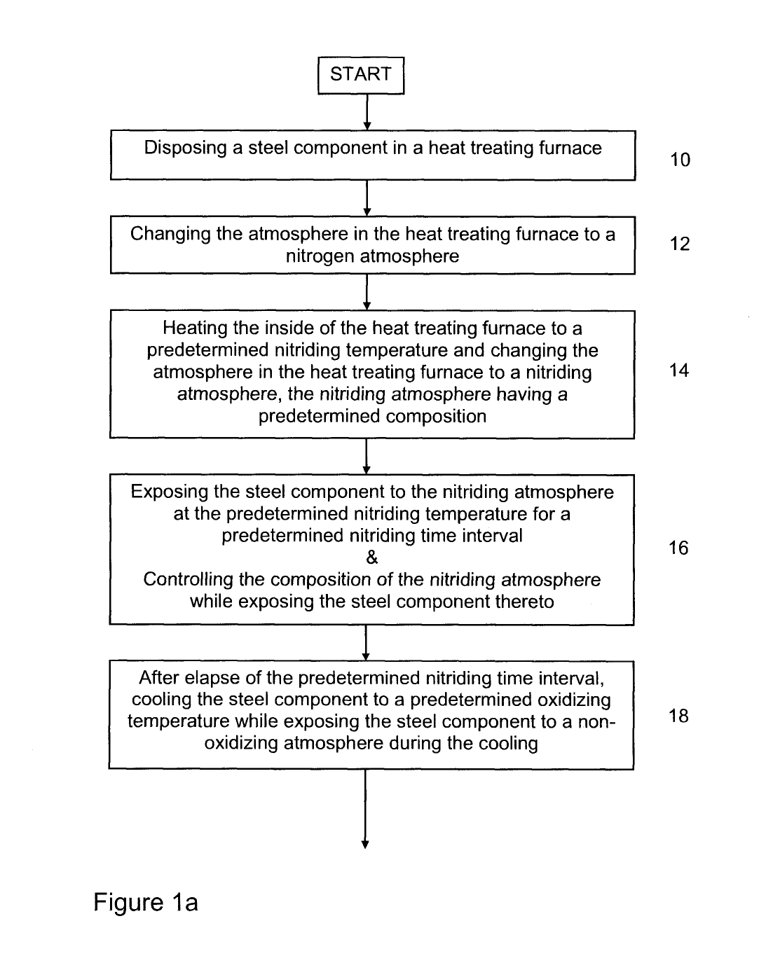

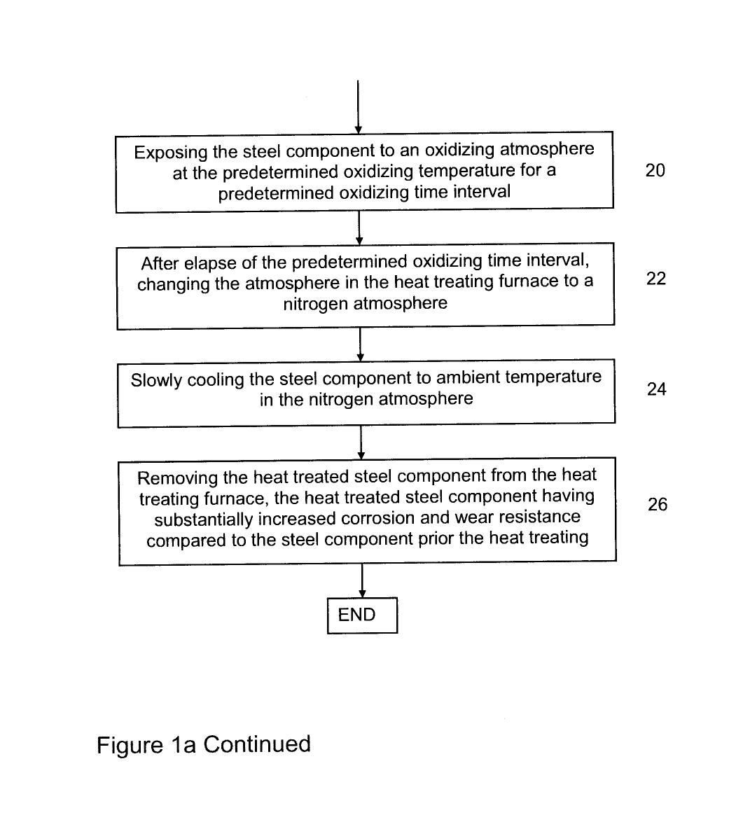

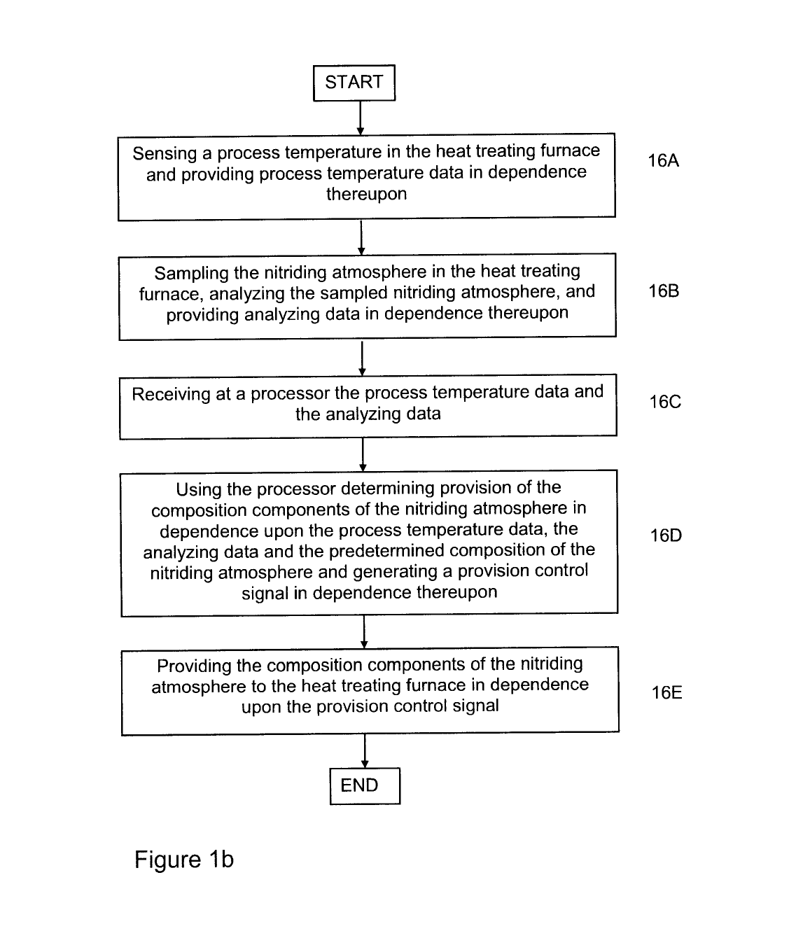

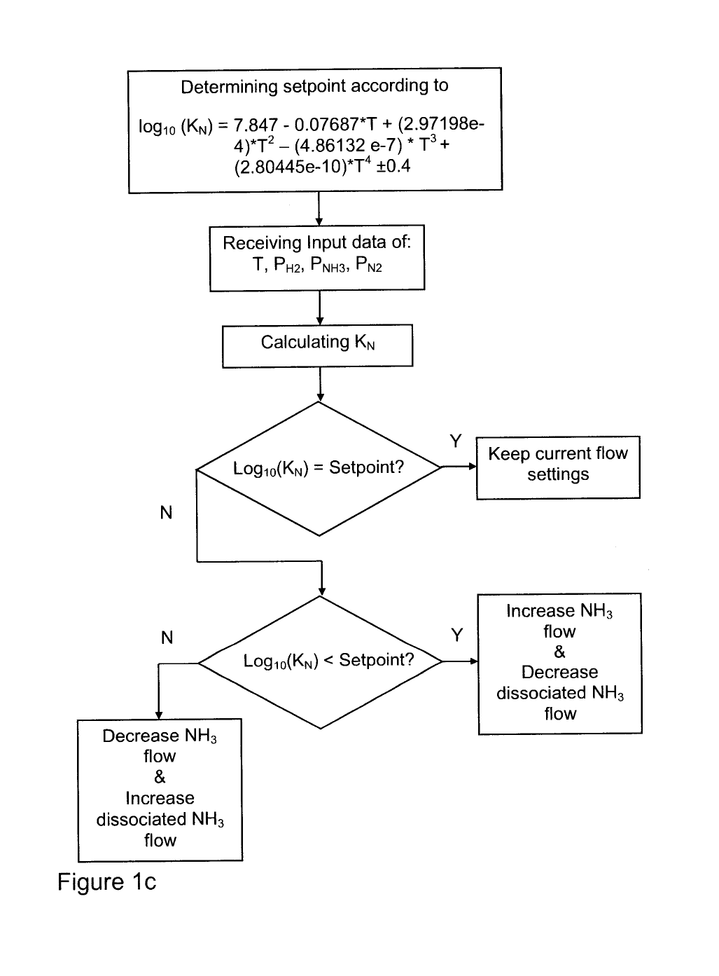

Referring to FIGS. 1a to 1c, a method for heat treating a steel component according to an embodiment of the invention is provided. At 10, the steel component is disposed in a heat treating furnace. For example, the heat treating furnace can be adapted for processing one or more long steel pipes such as drill pipes or heat exchanger pipes, as will be described in more detail hereinbelow. After disposing the steel component in the heat treating furnace and sealing of the same, the atmosphere inside the heat treating furnace is changed—12—to an explosion safe atmosphere, for example, a nitrogen atmosphere (N₂), in a security purge stage, using typically 5 furnace volumes of nitrogen. The inside of the heat treating furnace is then heated to a predetermined nitriding temperature. During the heating stage the atmosphere in the heat treating furnace is changed—14—to a nitriding atmosphere having a predetermined composition. The nitriding temperature can be within a range between 380° C. and 720° C., in one case, between 550° C. and 590° C. The nitriding atmosphere can be a mixture of ammonia (NH₃) and dissociated ammonia (dNH₃) with dNH₃ being 75 vol. % of H₂ and 25 vol. % of N₂.

The mixture of the nitriding atmosphere can be determined such that it satisfies the relationship between the partial pressures of the component gases—converted into the K_{N} number with K_{N}=P_{NH3}/(P_{H2})^{3/2}, (atm^{-0.5})—according to equation (1):

log₁₀(K_{N})=7.847−0.07687*T+(2.97198e−4)*T²−(4.86132 e−7)*T³+(2.80445e−10)*T⁴±0.4 (1)

where T is the nitriding temperature/process temperature, ° C.

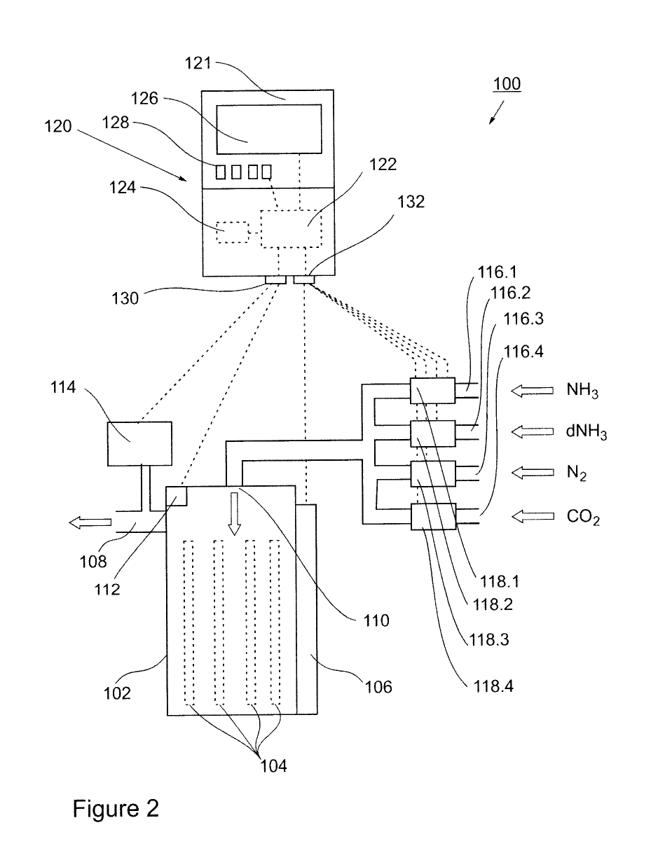

The steel component is then exposed to the nitriding atmosphere at the predetermined nitriding temperature for a predetermined nitriding time interval with the composition of the nitriding atmosphere being controlled while the steel component is exposed thereto—16. A particular method for controlling the atmosphere is illustrated in FIG. 1b. Using one or more state of the art temperature sensors, the process temperature inside the heat treating furnace is sensed and process temperature data in dependence thereupon are provided to a processor connected thereto—16A. Furthermore, the nitriding atmosphere in the heat treating furnace is sampled, for example, at the exhaust of the furnace, as illustrated in FIG. 2 and described hereinbelow. The sampled nitriding atmosphere is then analyzed using a state of the art gas analyzer and analyzing data in dependence thereupon are provided to the processor connected thereto—16B. After receipt—16C—of the input data, i.e. the process temperature data indicative of the process temperature T and the analyzing data indicative of the partial pressures P_{H2}, P_{NH3}, and P_{N2}, the processor determines the provision of the composition components of the nitriding atmosphere—16D—and generates a provision control signal in dependence thereupon. The provision control signal is received at standard gas flow control valves such as, for example, solenoid valves, and the composition components of the nitriding atmosphere are provided to the heat treating furnace in dependence thereupon—16E.

The provision of the composition components of the nitriding atmosphere can be determined according to the control procedure illustrated in FIG. 1c. Upon receipt of the input data, the processor calculates the K_{N} number in dependence thereupon. If Log₁₀(K_{N}) is equal the setpoint determined according to equation (1), the current flow settings for NH₃ and dNH₃ are kept. If Log₁₀(K_{N}) is smaller than the setpoint, the flow of NH₃ is increased and the flow of dNH₃ is decreased. If Log₁₀(K_{N}) is greater than the setpoint, the flow of NH₃ is decreased and the flow of dNH₃ is increased.

For example, the process temperature sensing and the nitriding atmosphere sampling is performed in predetermined time intervals and data indicative thereof are provided to the processor for performing the above determination of the provision of the composition components of the nitriding atmosphere using a standard PID control loop or a standard Fuzzy—type control loop.

This control process can be employed during the heating, the nitriding, and first cooling stages. During the nitriding stage the process temperature is maintained within a predetermined nitriding temperature range. The nitriding time interval is determined in a conventional manner dependent on the process temperature, the material, and the desired thickness of the nitrided layer. For example, for low carbon steel the nitriding time interval is approximately 10 hrs at 550° C.

Optionally, a flow of a carbon bearing gas—CO, CO₂, or a gaseous hydrocarbon—is added to the atmosphere for performing a nitrocarburizing process. The above control process is easily adapted by taking into account the presence of the carbon bearing gas in the calculation of the partial pressures. For example, in a typical nitrocarburizing process, CO₂ is added in the range of approximately 5-15 vol. %.

After elapse of the predetermined nitriding time interval, the steel component is cooled to a predetermined oxidizing temperature—18. During the cooling the steel component is exposed to a non-oxidizing atmosphere. After the predetermined oxidizing temperature has been reached the non-oxidizing atmosphere is changed, respective safe explosivity ranges, to an oxidizing atmosphere and the steel component is exposed thereto for a predetermined oxidizing time interval—20—for oxidizing the nitrided or nitrocarburized layer to further increase the corrosion resistance. For example, during the oxidizing stage the steel component is exposed to an oxidizing atmosphere of, for example, 100% CO₂, at an oxidizing temperature of 500° C. for an oxidizing time interval of approximately 30 minutes. Optionally, another oxygen containing gaseous mixture such as, for example, a nitrogen—air mixture, is used instead of CO₂.

After elapse of the predetermined oxidizing time interval, the atmosphere in the heat treating furnace is changed to a non-reactive gas atmosphere such as, for example, a nitrogen atmosphere—22—and the steel component is slowly cooled to ambient temperature or room temperature while being exposed to the non-reactive gas atmosphere—24. The steel component can be cooled to ambient temperature at a rate of 20° C./min or less.

It is noted that the oxidizing process may be performed at temperatures as high as the nitriding (nitrocarburizing) temperature, obviating step 18, down to approximately 350° C. as a separate stage or by continuously exchanging the oxidizing atmosphere during the cooling stage, obviating steps 18 and 22.

Optionally, the oxidizing process is omitted, thus obviating the steps 18 and 20.

After cooling to ambient temperature, the heat treated steel component is removed from the heat treating furnace—26. The heat treated steel component has substantially increased corrosion and wear resistance compared to the steel component prior the heat treating.

The method for heat treating a steel component according to an embodiment of the invention is applicable for heat treating all types of carbon steels and low alloyed steels with the sum of alloyed elements <5 mass %. Higher alloyed steels and stainless steels may require additional activation prior the nitriding stage using existing technology such as, for example, HCl acid activation.

The heat treating parameters are determined in dependence upon the type of steel material of the steel component, the desired surface finishing, and the desired corrosion and wear resistance of the steel component based on the knowledge of state of the art gas nitriding/nitrocarburizing processes.

Determination of the composition of the nitriding/nitrocarburizing atmosphere and control of the same during the nitriding/nitrocarburizing process based on the K_{N} number as defined in equation (1) can provide optimal conditions for white layer formation and growth during the heating and diffusion stages, resulting in a substantial increase of the corrosion resistance and the wear resistance of the steel component while obviating any quenching—rapid cooling—of the steel component substantially reducing the exposure of the same to thermal stress.

In preliminary experiments the above method for heat treating a steel component according to an embodiment of the invention has been applied to Schedule 80 black steel pipe Grade A material (according to ASTM A-53) which is most frequently used in geothermal heat exchangers.

The corrosion resistance of the material was tested using accelerated electro-corrosion testing—potentiodynamic Tafel cycling experiment in 1% (mass) water solution of NaCl at the temperature of 293K—applied to the untreated material, nitrocarburized material and nitrocarburized+oxidized material. Table 1 illustrates a substantial increase in corrosion resistance of the nitrocarburized material and the nitrocarburized+oxidized material.

TABLE 1

| | Electro corrosion | Material |
|---|---|---|
| | current density, | corrosion rate, |
| Parameter/Treatment | A/cm² | mm/year |
| Untreated Grade A material | 0.01 | 116 |
| Nitrocarburized Grade A material | 0.0008 | 9.28 |
| Nitrocarburized and Oxidized | 0.00001 | 0.116 |
| Grade A material | | |

The effect of nitrocarburizing on the wear resistance of material war studied using Atomic Force Microscopy. The treated sample was cut and polished using standard metallographic techniques. The final polishing stage with 3 micron diamond paste was extended to 15 minutes to reveal wear of material removed by polishing. The AFM scan of the cross section of the Nitrocarburized layer allows comparing the material removal on the core of the material and the Nitrocarburized zone. Table 2—summarizing the residual height of different zones with the ferrite level in the bulk of the sample being taken as Z=0—illustrates a substantial increase in wear resistance of the nitrocarburized material.

TABLE 2

| | | | | Gamma | | |
|---|---|---|---|---|---|---|
| | | Untreated | Epsilon | prime layer | Nitrocarburized | Nitrocarburized |
| | Untreated | zone | layer (top | (bottom of | diffusion layer | diffusion layer |
| | zone (bulk, | (bulk, | of white | white layer | at 50 microns | at 50 microns |
| | ferrite) | pearlite) | layer zone) | zone) | depth (ferrite) | depth (pearlite) |
| Average | 0 +/_ 8 | 82 +/_ 11 | 57 +/_ 28 | 69 +/_ 19 | 19 +/_ 8 | 95 +/_ 10 |
| residual | | | | | | |
| height Z, | | | | | | |
| nm | | | | | | |

FIG. 2 illustrates a heat treating furnace system for implementing the above method for heat treating a steel component. One or more steel components are disposed inside the heat treating furnace 102. The atmospheres used during the heat treating process are provided to the furnace 102 via inlet 110 and are removed therefrom via exhaust 108. The inlet 110 is connected a plurality of conduits, for example, 116.1-116.4 for receiving the various component gases from respective gas supplies. The provision of the component gases is controlled by respective valves 118.1-118.4 interposed in each of the conduits 116.1-116.4.

The heat treating process is controlled by computer 120 connected to: the temperature sensor 112 disposed inside the furnace 102; the gas analyzer 114 in fluid communication with the exhaust 108; the furnace heating mechanism 106; and, the valves 118.1-118.4. The computer 120 comprises a user interface 121 such as, for example, display 126 and keyboard 128, or a touch screen. The computer is operated using processor 122, for example, an off-the-shelf computer processor, for executing executable commands in one case stored in non-volatile memory 124 such as, for example, a hard-drive or flash memory. The processor is connected to the user interface, the memory, input port 130 and output port 132.

The pressure inside the furnace 102 can be controlled in a standard fashion, with the pressure being kept slightly above ambient air pressure to prevent leakage of air into the furnace 102.

It is noted that state of the art heat treating furnace systems are easily adapted for implementing the above method.

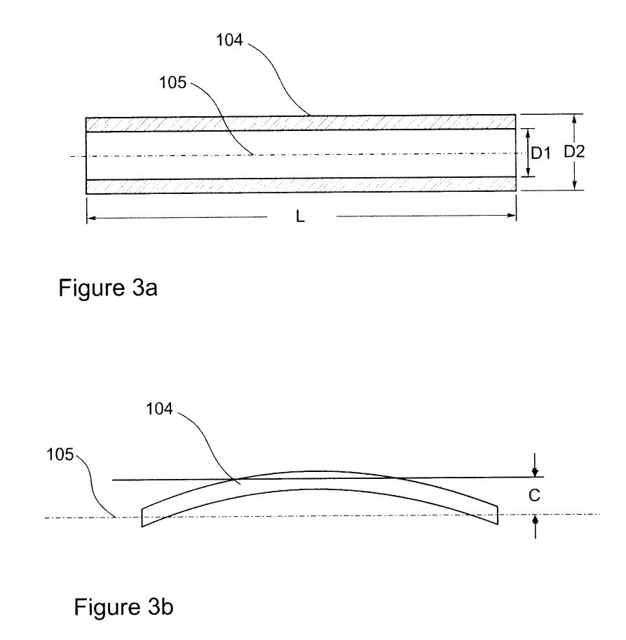

Steel pipes used in drilling and geothermal heat exchangers can be long pipes with: a ratio of internal diameter D1 to external diameter D2 greater 0.55; a ratio of external diameter D2 to length L less than 0.05 for pipes having an external diameter D2 up to 254 mm; and, a ratio of external diameter D2 to length L less than 0.1 for pipes having an external diameter D2 greater than 254 mm, as illustrated in FIG. 3a. Such steel pipes have to meet very restrictive manufacturing tolerances, in particular, with regard to straightness requiring the steel pipe to have a camber C of less than 1.1 mm per one meter of length, as illustrated in FIG. 3b.

The method for heat treating a steel component according to an embodiment of the invention substantially increases the corrosion resistance and the wear resistance of the steel component without any quenching—rapid cooling—of the steel component. The slow cooling process employed reduces the exposure of the steel component to thermal stress to the extent that it enables heat treating of long steel pipes as described hereinabove for substantially increasing the corrosion and wear resistance of the same while satisfying the required manufacturing tolerances.

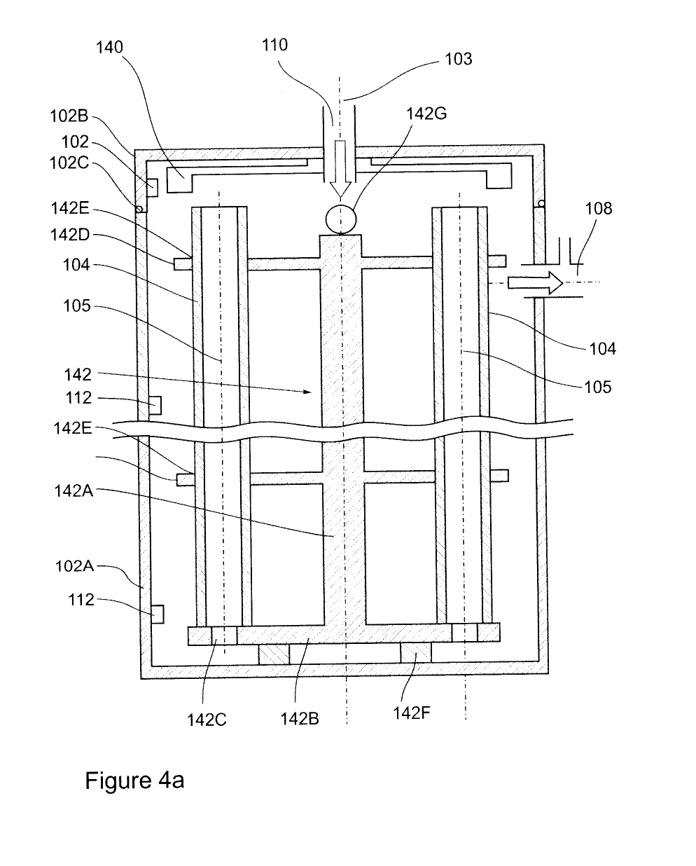

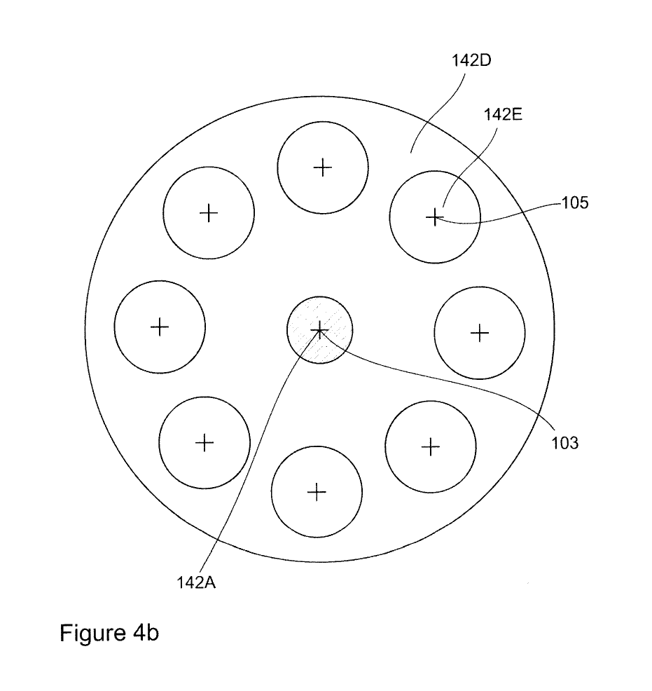

FIGS. 4a and 4b illustrate a heat treating furnace 102 adapted for heat treating long pipes used in drilling and heat exchangers having a length greater than 3 m—typically between 3 m and 12 m. The furnace 102 is, for example, a pit-type furnace having a retort 102A and a removable cover 102B. The cover 102B is removed for loading/unloading the steel pipes 104 into/from the retort 102A. During processing the cover 102B is mounted to the retort 102A in a sealed fashion via seal 102C. Rack 142 holds the steel pipes 104 along substantially vertically oriented axes 105. For example, the rack 142 comprises: holding plates 142D having bores 142E for accommodating the steel pipes 104 therein; bottom plate 142B for supporting the bottom of the steel pipes 104; and, vertical extension 142A having mounted the bottom plate 142B and the holding plates 142D mounted thereto. The bottom plate 142B comprises apertures 142C for enabling transmission of the heat treating atmosphere through the inside of the steel pipe. Furthermore, the rack 142 comprises a ring structure 142G mounted to the top of the vertical extension 142A for facilitating lifting and lowering of the same using, for example, a hook of a crane, and support elements 142F mounted to the bottom side of the bottom plate 142B for placing the bottom plate a predetermined distance above the bottom of the retort 102A.

The temperature sensors 112 are typically placed in several zones of the furnace 102—top, middle, and bottom. Uniformity of the heat treating atmosphere—with respect to temperature and composition—is achieved by forced recirculation of the same using recirculation turbine 140. The uniformity depends on the specific steel pipe material, geometry, and furnace design and is, typically within ±6° C. and ±2% relative to setpoint. The blades of the recirculation turbine 140 rotating about substantially vertical axis 103 mechanically accelerate the atmosphere provided by the inlet 110 towards the external zones resulting in a very efficient mixing of the atmosphere even in tall furnaces 102, thus exposing the inside and the outside of the steel pipes 104 to a substantially uniform atmosphere—with respect to temperature and composition—during the entire heat treating process.

Alternatively, the steel pipes may be treated having a horizontal orientation, provided the steel pipes have adequate support to prevent bending during treatment.

The present invention has been described herein with regard to certain embodiments. However, it will be obvious to persons skilled in the art that a number of variations and modifications can be made without departing from the scope of the invention as described herein.

What is claimed is:

1. A method for heat treating a steel component comprising:
disposing the steel component in a heat treating furnace;
exposing the steel component to a nitriding atmosphere at a predetermined nitriding temperature for a predetermined nitriding time interval, the nitriding atmosphere having a predetermined composition;
controlling the composition of the nitriding atmosphere while exposing the steel component thereto;
slowly cooling the steel component to ambient temperature; and,
removing the heat treated steel component from the heat treating furnace, the heat treated steel component having substantially increased corrosion and wear resistance compared to the steel component prior the heat treating.

2. The method according to claim 1 comprising exposing the steel component to an oxidizing atmosphere at a predetermined oxidizing temperature for a predetermined oxidizing time interval.

3. The method according to claim 2 comprising cooling the steel component to the oxidizing temperature and exposing the steel component to a non-oxidizing atmosphere during the cooling.

4. The method according to claim 1 wherein the steel component is cooled to ambient temperature at a rate of 20° C./min or less.

5. The method according to claim 1 comprising exposing the steel component to a non-reactive gas atmosphere during the cooling to ambient temperature.

6. The method according to claim 1 comprising adding a carbon bearing gas to the nitriding atmosphere.

7. The method according to claim 1 comprising analyzing the nitriding atmosphere in the heat treating furnace and providing analyzing data in dependence thereupon.

8. The method according to claim 7 comprising:
using a processor determining provision of the composition components of the nitriding atmosphere in dependence upon the analyzing data and the predetermined composition of the nitriding atmosphere and generating a provision control signal in dependence thereupon; and,
providing the composition components of the nitriding atmosphere to the heat treating furnace in dependence upon the provision control signal.

9. The method according to claim 8 wherein the composition components comprise an ammonia-based atmosphere.

10. The method according to claim 8 wherein the composition components comprise an ammonia-based atmosphere and a carbon bearing gas.

11. The method according to claim 1 wherein disposing the steel component comprises disposing a long steel pipe.

12. The method according to claim 11 wherein disposing the steel component comprises disposing one of a drill pipe and a heat exchanger pipe.

13. A long steel pipe having an inside surface and an outside surface, the inside surface and the outside surface having a heat treating surface layer generated by the method for heat treating according to claim 1.

14. The steel pipe according to claim 13 wherein the steel pipe has:
a ratio of internal diameter to external diameter greater 0.55;
a ratio of external diameter to length less than 0.05 for pipes having an external diameter up to 254 mm; and,
a ratio of external diameter to length less than 0.1 for pipes having an external diameter greater than 254 mm.

15. The steel pipe according to claim 14 wherein the steel pipe has a camber of less than 1.1 mm per one meter of length.

16. The steel pipe according to claim 13 wherein the steel pipe is one of a drill pipe and a heat exchanger pipe.

17. The steel pipe according to claim 13 wherein the steel pipe is made of one of carbon steel and low alloyed steel.

18. A long steel pipe having an inside surface and an outside surface, wherein the inside surface and the outside surface has a heat treating surface layer providing substantial corrosion and wear resistance, and wherein the steel pipe has a camber of less than 1.1 mm per one meter of length.

19. The steel pipe according to claim 18 wherein the steel pipe has:
a ratio of internal diameter to external diameter greater 0.55;
a ratio of external diameter to length less than 0.05 for pipes having an external diameter up to 254 mm; and,
a ratio of external diameter to length less than 0.1 for pipes having an external diameter greater than 254 mm.

20. The steel pipe according to claim 18 wherein the steel pipe is one of a drill pipe and a heat exchanger pipe.

21. The steel pipe according to claim 20 wherein the steel pipe is made of one of carbon steel and low alloyed steel.
